(19) United States
(12) Patent Application Publication
(10) Pub. No.: US 2026/0057664 A1
(43) Pub. Date: Feb. 26, 2026

(54) SYSTEM

(71) Applicant: SoftBank Group Corp., Tokyo (JP)

(72) Inventor: Kotaku KIHARA, Tokyo (JP)

(21) Appl. No.: 19/295,801

(22) Filed: Aug. 11, 2025

(30) Foreign Application Priority Data
Aug. 23, 2024 (JP) 2024-142108

(51) Int. Cl. G06V 10/94; G06F 3/01; G06V 20/40

(52) U.S. Cl. CPC G06V 10/945; G06F 3/011; G06V 20/40; G06F 2203/011

(57) ABSTRACT

The system according to the embodiment comprises an acquisition unit, a recognition unit, a reference unit, and a provision unit. The acquisition unit acquires tap information. The recognition unit recognizes an item based on the tap information acquired by the acquisition unit. The reference unit acquires related information based on the item information recognized by the recognition unit. The provision unit provides the information acquired by the reference unit.

### CROSS-REFERENCE TO RELATED APPLICATION

The present application claims priority to and incorporates by reference the entire contents of Japanese Patent Application No. 2024-142108 filed in Japan on Aug. 23, 2024.

### BACKGROUND OF THE INVENTION

### Field of the Invention

The technology of this disclosure relates to the system.

### Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

In conventional technology, there has been a problem that it is difficult for viewers to easily obtain information about items within video content.

### SUMMARY OF THE INVENTION

The system according to the embodiment comprises an acquisition unit, a recognition unit, a reference unit, and a provision unit. The acquisition unit acquires tap information. The recognition unit recognizes an item based on the tap information acquired by the acquisition unit. The reference unit acquires related information based on the item information recognized by the recognition unit. The provision unit provides the information acquired by the reference unit.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor with a sign (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) with a sign is a memory where information is temporarily stored and used as a work memory by the processor.

In the following embodiments, a storage with a sign is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) with a sign is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B.

Moreover, when expressing three or more items connected by “and/or,” the same concept as “A and/or B” applies.

### First Embodiment

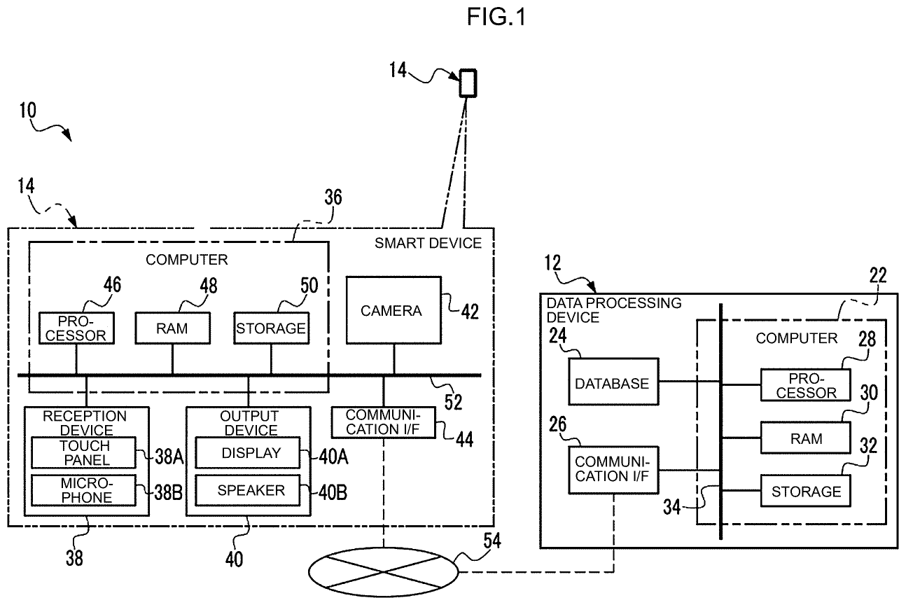

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, and camera 42 are also connected to the bus 52.

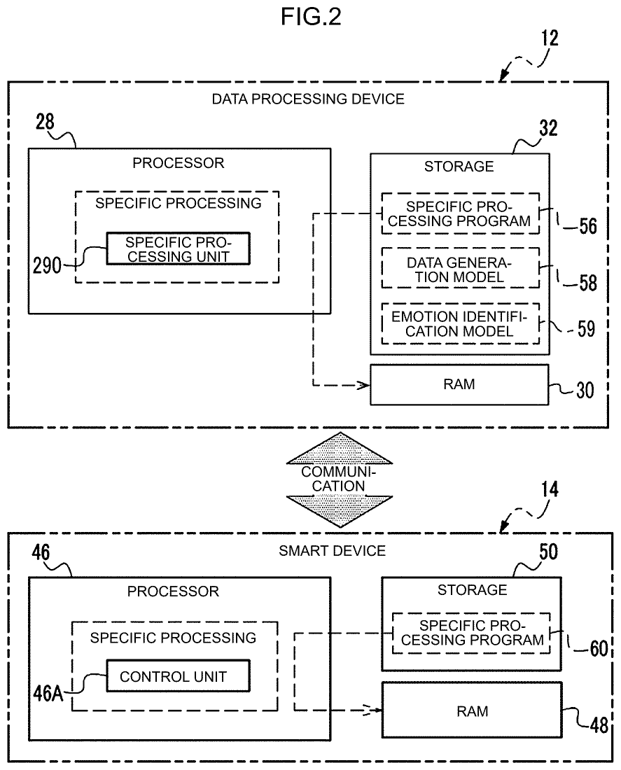

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 comprises a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example 1 of Embodiment

The information provision system according to the embodiment of the present invention is a system in which a viewer taps an item appearing in video content on a device, and AI acquires and provides the information to the viewer. The information provision system allows the viewer to obtain information by tapping an item of interest while watching video content on a device. For example, if the viewer taps an actress, her profile is displayed; if the viewer taps clothing, information about the sales site is provided. Even if the video is of low accuracy, the AI can refer to EC data to provide accurate information. As a result, viewers can easily obtain information about items of interest while watching videos. Thus, the information provision system enables viewers to easily obtain information about items of interest while enjoying video content, thereby increasing their willingness to purchase. In addition, for companies, it is possible to provide product information through video content and guide users to EC sites, so marketing effects can be expected.

The information provision system according to the embodiment comprises an acquisition unit, a recognition unit, a reference unit, and a provision unit. The acquisition unit acquires tap information when a viewer taps an item of interest while watching video content on a device. For example, the acquisition unit can acquire information such as the position, time, and strength of the tap. The acquisition unit can also estimate the user's emotion and adjust the timing of acquiring tap information based on the estimated user's emotion. The recognition unit recognizes the tapped item based on the tap information acquired by the acquisition unit. For example, the recognition unit can recognize the tapped item using image recognition technology. The recognition unit can also estimate the user's emotion and adjust the accuracy of item recognition based on the estimated user's emotion. The reference unit acquires related information based on the item information recognized by the recognition unit. For example, the reference unit can refer to EC databases and other related databases to obtain detailed product information, reviews, prices, etc. The reference unit can also estimate the user's emotion and select the database to refer to based on the estimated user's emotion. The provision unit provides the information acquired by the reference unit to the viewer. For example, the provision unit can provide information by means such as pop-up display, notification, or email. The provision unit can also estimate the user's emotion and adjust the method of information provision based on the estimated user's emotion. In this way, the information provision system according to the embodiment enables viewers to easily obtain information about items of interest while watching video content. For example, if the viewer taps an actress, her profile is displayed; if the viewer taps clothing, information about the sales site is provided. Even if the video is of low accuracy, the AI can refer to EC data to provide accurate information. As a result, viewers can easily obtain information about items of interest while watching videos.

The reference unit can refer to an EC database. The EC database may include, for example, databases such as Yahoo! (registered trademark) Shopping, Amazon (registered trademark), but is not limited thereto. For example, the reference unit can refer to the EC database to obtain detailed product information, reviews, prices, etc. This enables accurate acquisition of product information by referring to the EC database. Some or all of the above-described processing in the reference unit may be performed using AI, or may be performed without using AI. For example, the reference unit can input the EC database to AI and have the AI acquire detailed product information, reviews, prices, etc.

The reference unit can refer to other related databases. Related databases may include, for example, industry-specific databases, open databases, etc., but are not limited thereto. The reference unit can, for example, refer to related databases to obtain a wide range of information. Thus, by referring to related databases, a wide range of information can be obtained. Some or all of the above-described processing in the reference unit may be performed using AI, or may be performed without using AI. For example, the reference unit can input related databases to AI and have the AI acquire a wide range of information. The recognition unit can recognize the tapped item.

For example, the recognition unit recognizes the tapped item using image recognition technology. For example, the recognition unit analyzes the image of the tapped item, extracts its features, and recognizes it. The recognition unit can also recognize the tapped item using location information. For example, the recognition unit identifies the position of the item based on the tapped location information and acquires that information. The recognition unit can also estimate the user's emotion and adjust the accuracy of item recognition based on the estimated user's emotion. This enables accurate recognition of the tapped item. Some or all of the above-described processing in the recognition unit may be performed using AI, or may be performed without using AI. For example, the recognition unit can input the image data of the tapped item to AI and have the AI perform item recognition.

The provision unit can provide information to the viewer. For example, the provision unit provides information by means such as pop-up display, notification, or email. For example, the provision unit provides information about the tapped item to the viewer via a pop-up display. The provision unit can also provide information about the tapped item to the viewer via notification. The provision unit can also provide information about the tapped item to the viewer via email. This enables prompt provision of information to the viewer. Some or all of the above-described processing in the provision unit may be performed using AI, or may be performed without using AI. For example, the provision unit can input information about the tapped item to AI and have the AI perform the method of information provision.

The acquisition unit can analyze the user's past tap history and select an appropriate acquisition method. For example, the acquisition unit analyzes patterns of items that the user has frequently tapped in the past and preferentially acquires similar items. For example, the acquisition unit analyzes tap trends during specific time periods from the user's tap history and selects the optimal acquisition method for those time periods. The acquisition unit can also customize the acquisition method for specific content genres based on the user's tap history. This enables selection of the optimal acquisition method based on past tap history. Some or all of the above-described processing in the acquisition unit may be performed using AI, or may be performed without using AI. For example, the acquisition unit can input the user's tap history data to AI and have the AI select the optimal acquisition method.

The acquisition unit can perform filtering based on the user's current viewing content and areas of interest when acquiring tap information. For example, the acquisition unit preferentially acquires tap information for items related to the genre of content the user is viewing. For example, the acquisition unit filters and acquires tap information for highly relevant items based on the user's areas of interest. The acquisition unit can also acquire tap information at appropriate timing according to the scene of the content the user is viewing. This enables filtering of tap information based on viewing content and areas of interest. Some or all of the above-described processing in the acquisition unit may be performed using AI, or may be performed without using AI. For example, the acquisition unit can input the user's viewing content and interest area data to AI and have the AI perform filtering of tap information.

The acquisition unit can select an appropriate acquisition means according to the user's input method when acquiring tap information. For example, if the user is using voice input, the acquisition unit acquires tap information based on voice commands. For example, if the user is using gesture input, the acquisition unit acquires tap information based on gesture movements. The acquisition unit can also acquire tap information based on entered text if the user is using text input. This enables selection of the optimal acquisition means according to the user's input method. Some or all of the above-described processing in the acquisition unit may be performed using AI, or may be performed without using AI. For example, the acquisition unit can input the user's input method data to AI and have the AI select the optimal acquisition means.

The acquisition unit can preferentially acquire highly relevant information by taking into account the user's geographic location information when acquiring tap information. For example, if the user is in a specific region, the acquisition unit preferentially acquires tap information for items related to that region. For example, if the user is traveling, the acquisition unit preferentially acquires tap information for items related to the travel destination. The acquisition unit can also preferentially acquire tap information for items related to stores or services around the user's home if the user is at home. This enables acquisition of highly relevant information by considering geographic location information. Some or all of the above-described processing in the acquisition unit may be performed using AI, or may be performed without using AI. For example, the acquisition unit can input the user's geographic location information to AI and have the AI acquire highly relevant information.

The acquisition unit can analyze the user's social media activity and acquire related information when acquiring tap information. For example, the acquisition unit acquires tap information for items related to places where the user has checked in on social media. For example, the acquisition unit analyzes the user's social media posts and acquires tap information for related items. The acquisition unit can also acquire tap information for related items by referring to the activities of the user's friends on social media. This enables acquisition of related information based on social media activity. Some or all of the above-described processing in the acquisition unit may be performed using AI, or may be performed without using AI. For example, the acquisition unit can input the user's social media activity data to AI and have the AI acquire related information.

The acquisition unit can customize the acquisition method by reflecting the user's past feedback when acquiring tap information. For example, the acquisition unit optimizes the acquisition method based on feedback provided by the user in the past. For example, the acquisition unit customizes the acquisition method for specific items based on the user's past feedback. The acquisition unit can also analyze the user's feedback and reflect improvements in the acquisition method. This enables customization of the acquisition method based on past feedback. Some or all of the above-described processing in the acquisition unit may be performed using AI, or may be performed without using AI. For example, the acquisition unit can input the user's past feedback data to AI and have the AI customize the acquisition method.

The recognition unit can adjust the recognition accuracy based on the importance of the item during recognition. For example, the recognition unit performs detailed recognition for highly important items. For example, the recognition unit performs simplified recognition for less important items. The recognition unit can also dynamically adjust the recognition accuracy according to the importance of the item. This enables adjustment of recognition accuracy according to the importance of the item. Some or all of the above-described processing in the recognition unit may be performed using AI, or may be performed without using AI. For example, the recognition unit can input item importance data to AI and have the AI adjust the recognition accuracy.

The recognition unit can apply different recognition algorithms according to the category of the item during recognition. For example, the recognition unit applies a fashion-specific recognition algorithm to clothing items. For example, the recognition unit applies a technology-specific recognition algorithm to electronic device items. The recognition unit can also apply a food-specific recognition algorithm to food items. This enables application of recognition algorithms according to the category of the item. Some or all of the above-described processing in the recognition unit may be performed using AI, or may be performed without using AI. For example, the recognition unit can input item category data to AI and have the AI apply the recognition algorithm.

The recognition unit can improve recognition accuracy by referring to the user's past recognition results during recognition. For example, the recognition unit improves recognition accuracy based on data of items recognized by the user in the past. For example, the recognition unit adjusts recognition accuracy for specific items based on the user's past recognition results. The recognition unit can also analyze the user's past recognition history and optimize the recognition algorithm. This enables improvement of recognition accuracy based on past recognition results. Some or all of the above-described processing in the recognition unit may be performed using AI, or may be performed without using AI. For example, the recognition unit can input the user's past recognition result data to AI and have the AI improve recognition accuracy.

The recognition unit can determine the recognition priority based on the submission timing of the item during recognition. For example, the recognition unit preferentially recognizes recently tapped items. For example, the recognition unit postpones items that have not been tapped for a long time. The recognition unit can also dynamically adjust the recognition priority according to the submission timing. This enables determination of recognition priority according to the submission timing. Some or all of the above-described processing in the recognition unit may be performed using AI, or may be performed without using AI. For example, the recognition unit can input item submission timing data to AI and have the AI determine the recognition priority.

The recognition unit can adjust the recognition order based on the relevance of the item during recognition. For example, the recognition unit preferentially recognizes highly relevant items. For example, the recognition unit postpones less relevant items. The recognition unit can also dynamically adjust the recognition order according to the relevance of the item. This enables adjustment of the recognition order according to the relevance of the item. Some or all of the above-described processing in the recognition unit may be performed using AI, or may be performed without using AI. For example, the recognition unit can input item relevance data to AI and have the AI adjust the recognition order.

The recognition unit can adjust the use of technical terms in recognition results according to the user's level of expertise during recognition. For example, for users with a high level of expertise, the recognition unit provides recognition results using detailed technical terms. For example, for users with a low level of expertise, the recognition unit provides recognition results using simple terms. The recognition unit can also dynamically adjust the use of technical terms in recognition results according to the user's level of expertise. This enables adjustment of the use of technical terms in recognition according to the user's level of expertise. Some or all of the above-described processing in the recognition unit may be performed using AI, or may be performed without using AI. For example, the recognition unit can input the user's expertise level data to AI and have the AI perform the use of technical terms.

The reference unit can adjust the reference accuracy based on the importance of the item during reference. For example, the reference unit refers to detailed information for highly important items. For example, the reference unit refers to simplified information for less important items. The reference unit can also dynamically adjust the reference accuracy according to the importance of the item. This enables adjustment of reference accuracy according to the importance of the item. Some or all of the above-described processing in the reference unit may be performed using AI, or may be performed without using AI. For example, the reference unit can input item importance data to AI and have the AI adjust the reference accuracy.

The reference unit can apply different reference algorithms according to the category of the item during reference. For example, the reference unit applies a fashion-specific reference algorithm to clothing items. For example, the reference unit applies a technology-specific reference algorithm to electronic device items. The reference unit can also apply a food-specific reference algorithm to food items. This enables application of reference algorithms according to the category of the item. Some or all of the above-described processing in the reference unit may be performed using AI, or may be performed without using AI. For example, the reference unit can input item category data to AI and have the AI apply the reference algorithm.

The reference unit can improve reference accuracy by referring to the user's past reference results during reference. For example, the reference unit improves reference accuracy based on data of items referred to by the user in the past. For example, the reference unit adjusts reference accuracy for specific items based on the user's past reference results. The reference unit can also analyze the user's past reference history and optimize the reference algorithm. This enables improvement of reference accuracy based on past reference results. Some or all of the above-described processing in the reference unit may be performed using AI, or may be performed without using AI. For example, the reference unit can input the user's past reference result data to AI and have the AI improve reference accuracy.

The reference unit can determine the reference priority based on the submission timing of the item during reference. For example, the reference unit preferentially refers to recently tapped items. For example, the reference unit postpones items that have not been tapped for a long time. The reference unit can also dynamically adjust the reference priority according to the submission timing. This enables determination of reference priority according to the submission timing. Some or all of the above-described processing in the reference unit may be performed using AI, or may be performed without using AI. For example, the reference unit can input item submission timing data to AI and have the AI determine the reference priority.

The reference unit can adjust the reference order based on the relevance of the item during reference. For example, the reference unit preferentially refers to highly relevant items. For example, the reference unit postpones less relevant items. The reference unit can also dynamically adjust the reference order according to the relevance of the item. This enables adjustment of the reference order according to the relevance of the item. Some or all of the above-described processing in the reference unit may be performed using AI, or may be performed without using AI. For example, the reference unit can input item relevance data to AI and have the AI adjust the reference order.

The reference unit can adjust the use of technical terms in reference results according to the user's level of expertise during reference. For example, for users with a high level of expertise, the reference unit provides reference results using detailed technical terms. For example, for users with a low level of expertise, the reference unit provides reference results using simple terms. The reference unit can also dynamically adjust the use of technical terms in reference results according to the user's level of expertise. This enables adjustment of the use of technical terms in reference according to the user's level of expertise. Some or all of the above-described processing in the reference unit may be performed using AI, or may be performed without using AI. For example, the reference unit can input the user's expertise level data to AI and have the AI perform the use of technical terms.

The provision unit can adjust the provision accuracy based on the importance of the information during provision. For example, the provision unit provides detailed information for highly important information. For example, the provision unit provides simplified information for less important information. The provision unit can also dynamically adjust the provision accuracy according to the importance of the information. This enables adjustment of provision accuracy according to the importance of the information. Some or all of the above-described processing in the provision unit may be performed using AI, or may be performed without using AI. For example, the provision unit can input information importance data to AI and have the AI adjust the provision accuracy.

The provision unit can apply different provision algorithms according to the category of the information during provision. For example, the provision unit applies a fashion-specific provision algorithm to clothing information. For example, the provision unit applies a technology-specific provision algorithm to electronic device information. The provision unit can also apply a food-specific provision algorithm to food information. This enables application of provision algorithms according to the category of the information. Some or all of the above-described processing in the provision unit may be performed using AI, or may be performed without using AI. For example, the provision unit can input information category data to AI and have the AI apply the provision algorithm.

The provision unit can improve provision accuracy by referring to the user's past provision results during provision. For example, the provision unit improves provision accuracy based on data of information provided to the user in the past. For example, the provision unit adjusts provision accuracy for specific information based on the user's past provision results. The provision unit can also analyze the user's past provision history and optimize the provision algorithm. This enables improvement of provision accuracy based on past provision results. Some or all of the above-described processing in the provision unit may be performed using AI, or may be performed without using AI. For example, the provision unit can input the user's past provision result data to AI and have the AI improve provision accuracy.

The provision unit can determine the provision priority based on the submission timing of the information during provision. For example, the provision unit preferentially provides recently acquired information. For example, the provision unit postpones information that has not been acquired for a long time. The provision unit can also dynamically adjust the provision priority according to the submission timing. This enables determination of provision priority according to the submission timing. Some or all of the above-described processing in the provision unit may be performed using AI, or may be performed without using AI. For example, the provision unit can input information submission timing data to AI and have the AI determine the provision priority.

The provision unit can adjust the provision order based on the relevance of the information during provision. For example, the provision unit preferentially provides highly relevant information. For example, the provision unit postpones less relevant information. The provision unit can also dynamically adjust the provision order according to the relevance of the information. This enables adjustment of the provision order according to the relevance of the information. Some or all of the above-described processing in the provision unit may be performed using AI, or may be performed without using AI. For example, the provision unit can input information relevance data to AI and have the AI adjust the provision order.

The provision unit can adjust the use of technical terms in information provision according to the user's level of expertise during provision. For example, for users with a high level of expertise, the provision unit provides information using detailed technical terms. For example, for users with a low level of expertise, the provision unit provides information using simple terms. The provision unit can also dynamically adjust the use of technical terms in provided information according to the user's level of expertise. This enables adjustment of the use of technical terms in provision according to the user's level of expertise. Some or all of the above-described processing in the provision unit may be performed using AI, or may be performed without using AI. For example, the provision unit can input the user's expertise level data to AI and have the AI perform the use of technical terms.

The system according to the embodiment is not limited to the above-described examples, and various modifications are possible, for example, as follows.

The acquisition unit can analyze the user's past purchase history and preferentially acquire information about related items. For example, the acquisition unit preferentially acquires tap information for similar items based on data of items the user has purchased in the past. The acquisition unit can also analyze the user's interest in specific brands or categories from the purchase history and preferentially acquire such information. Furthermore, the acquisition unit can preferentially acquire information about items according to the season or trend based on the user's purchase history. This enables efficient acquisition of related information based on the user's purchase history.

The recognition unit can utilize the user's gaze tracking data to preferentially recognize items on which the gaze is focused. For example, the recognition unit preferentially recognizes items on which the user's gaze remains for a long time. The recognition unit can also analyze gaze movement patterns and preferentially recognize items that are likely to be of interest. Furthermore, the recognition unit can adjust the recognition accuracy according to the degree of gaze concentration and enhance the recognition accuracy for items on which the gaze is focused. This enables efficient recognition of items of interest by utilizing the user's gaze data.

The reference unit can analyze the user's social media activity and acquire related information. For example, the reference unit preferentially acquires information about brands or influencers followed by the user on social media. The reference unit can also analyze the user's posts and comments to acquire information related to topics of interest. Furthermore, the reference unit can acquire related information by referring to the activities of the user's friends on social media. This enables efficient acquisition of related information based on social media activity.

The provision unit can adjust the method of information provision based on the user's device usage status. For example, if the user is using a smartphone, the provision unit provides information in a manner suitable for the screen size. The provision unit can also provide information in a manner that utilizes the large screen if the user is using a tablet. Furthermore, if the user is using a desktop, the provision unit can provide information using multiple windows. This enables provision of information in the optimal manner according to the user's device usage status.

The acquisition unit can preferentially acquire highly relevant information by taking into account the user's geographic location information. For example, if the user is in a specific region, the acquisition unit preferentially acquires tap information for items related to that region. The acquisition unit can also preferentially acquire tap information for items related to the travel destination if the user is traveling. Furthermore, if the user is at home, the acquisition unit can preferentially acquire tap information for items related to stores or services around the user's home. This enables acquisition of highly relevant information by considering geographic location information.

The following is a brief description of the processing flow of Example 1 of the Embodiment.

Step 1: The acquisition unit acquires tap information when a viewer taps an item of interest while watching video content on a device. For example, the acquisition unit can acquire information such as the position, time, and strength of the tap. The acquisition unit can also estimate the user's emotion and adjust the timing of acquiring tap information based on the estimated user's emotion.

Step 2: The recognition unit recognizes the tapped item based on the tap information acquired by the acquisition unit. For example, the recognition unit can recognize the tapped item using image recognition technology. The recognition unit can also estimate the user's emotion and adjust the accuracy of item recognition based on the estimated user's emotion.

Step 3: The reference unit acquires related information based on the item information recognized by the recognition unit. For example, the reference unit can refer to EC databases and other related databases to obtain detailed product information, reviews, prices, etc. The reference unit can also estimate the user's emotion and select the database to refer to based on the estimated user's emotion.

Step 4: The provision unit provides the information acquired by the reference unit to the viewer. For example, the provision unit can provide information by means such as pop-up display, notification, or email. The provision unit can also estimate the user's emotion and adjust the method of information provision based on the estimated user's emotion.

### Example 2 of Embodiment

The information provision system according to the embodiment of the present invention is a system in which a viewer taps an item appearing in video content on a device, and AI acquires and provides the information to the viewer. The information provision system allows the viewer to obtain information by tapping an item of interest while watching video content on a device. For example, if the viewer taps an actress, her profile is displayed; if the viewer taps clothing, information about the sales site is provided. Even if the video is of low accuracy, the AI can refer to EC data to provide accurate information. As a result, viewers can easily obtain information about items of interest while watching videos. Thus, the information provision system enables viewers to easily obtain information about items of interest while enjoying video content, thereby increasing their willingness to purchase. In addition, for companies, it is possible to provide product information through video content and guide users to EC sites, so marketing effects can be expected.

The information provision system according to the embodiment comprises an acquisition unit, a recognition unit, a reference unit, and a provision unit. The acquisition unit acquires tap information when a viewer taps an item of interest while watching video content on a device. For example, the acquisition unit can acquire information such as the position, time, and strength of the tap. The acquisition unit can also estimate the user's emotion and adjust the timing of acquiring tap information based on the estimated user's emotion. The recognition unit recognizes the tapped item based on the tap information acquired by the acquisition unit. For example, the recognition unit can recognize the tapped item using image recognition technology. The recognition unit can also estimate the user's emotion and adjust the accuracy of item recognition based on the estimated user's emotion. The reference unit acquires related information based on the item information recognized by the recognition unit. For example, the reference unit can refer to EC databases and other related databases to obtain detailed product information, reviews, prices, etc. The reference unit can also estimate the user's emotion and select the database to refer to based on the estimated user's emotion. The provision unit provides the information acquired by the reference unit to the viewer. For example, the provision unit can provide information by means such as pop-up display, notification, or email. The provision unit can also estimate the user's emotion and adjust the method of information provision based on the estimated user's emotion. In this way, the information provision system according to the embodiment enables viewers to easily obtain information about items of interest while watching video content. For example, if the viewer taps an actress, her profile is displayed; if the viewer taps clothing, information about the sales site is provided. Even if the video is of low accuracy, the AI can refer to EC data to provide accurate information. As a result, viewers can easily obtain information about items of interest while watching videos.

The reference unit can refer to an EC database. The EC database may include, for example, databases such as Yahoo! Shopping, Amazon, but is not limited thereto. For example, the reference unit can refer to the EC database to obtain detailed product information, reviews, prices, etc. This enables accurate acquisition of product information by referring to the EC database. Some or all of the above-described processing in the reference unit may be performed using AI, or may be performed without using AI. For example, the reference unit can input the EC database to AI and have the AI acquire detailed product information, reviews, prices, etc.

The reference unit can refer to other related databases. Related databases may include, for example, industry-specific databases, open databases, etc., but are not limited thereto. The reference unit can, for example, refer to related databases to obtain a wide range of information. Thus, by referring to related databases, a wide range of information can be obtained. Some or all of the above-described processing in the reference unit may be performed using AI, or may be performed without using AI. For example, the reference unit can input related databases to AI and have the AI acquire a wide range of information.

The recognition unit can recognize the tapped item. For example, the recognition unit recognizes the tapped item using image recognition technology. For example, the recognition unit analyzes the image of the tapped item, extracts its features, and recognizes it. The recognition unit can also recognize the tapped item using location information. For example, the recognition unit identifies the position of the item based on the tapped location information and acquires that information. The recognition unit can also estimate the user's emotion and adjust the accuracy of item recognition based on the estimated user's emotion. This enables accurate recognition of the tapped item. Some or all of the above-described processing in the recognition unit may be performed using AI, or may be performed without using AI. For example, the recognition unit can input the image data of the tapped item to AI and have the AI perform item recognition.

The provision unit can provide information to the viewer. For example, the provision unit provides information by means such as pop-up display, notification, or email. For example, the provision unit provides information about the tapped item to the viewer via a pop-up display. The provision unit can also provide information about the tapped item to the viewer via notification. The provision unit can also provide information about the tapped item to the viewer via email. This enables prompt provision of information to the viewer. Some or all of the above-described processing in the provision unit may be performed using AI, or may be performed without using AI. For example, the provision unit can input information about the tapped item to AI and have the AI perform the method of information provision.

The acquisition unit can estimate the user's emotion and adjust the timing of acquiring tap information based on the estimated user's emotion. For example, the acquisition unit captures the user's facial expression with a camera and estimates the emotion using an emotion estimation algorithm. For example, the acquisition unit calculates an emotion score based on changes in facial expression. The acquisition unit can also record the user's voice and estimate the emotion using voice analysis technology. For example, the acquisition unit analyzes the tone and speed of the voice to calculate an emotion score. The acquisition unit can also collect the user's biometric data (such as heart rate or skin conductance) with a sensor and estimate the emotion using an emotion estimation algorithm. For example, the acquisition unit calculates an emotion score based on heart rate variability. This enables optimization of the timing of acquiring tap information according to the user's emotion. Emotion estimation is realized, for example, by using an emotion engine or generative AI as an emotion estimation function. The generative AI may be a text generation AI (e.g., LLM) or a multimodal generative AI, but is not limited thereto. Some or all of the above-described processing in the acquisition unit may be performed using AI, or may be performed without using AI. For example, the acquisition unit can input the user's image data captured by the camera to the generative AI and have the generative AI estimate the user's emotion.

The acquisition unit can analyze the user's past tap history and select an appropriate acquisition method. For example, the acquisition unit analyzes patterns of items that the user has frequently tapped in the past and preferentially acquires similar items. For example, the acquisition unit analyzes tap trends during specific time periods from the user's tap history and selects the optimal acquisition method for those time periods. The acquisition unit can also customize the acquisition method for specific content genres based on the user's tap history. This enables selection of the optimal acquisition method based on past tap history. Some or all of the above-described processing in the acquisition unit may be performed using AI, or may be performed without using AI. For example, the acquisition unit can input the user's tap history data to AI and have the AI select the optimal acquisition method.

The acquisition unit can perform filtering based on the user's current viewing content and areas of interest when acquiring tap information. For example, the acquisition unit preferentially acquires tap information for items related to the genre of content the user is viewing. For example, the acquisition unit filters and acquires tap information for highly relevant items based on the user's areas of interest. The acquisition unit can also acquire tap information at appropriate timing according to the scene of the content the user is viewing. This enables filtering of tap information based on viewing content and areas of interest. Some or all of the above-described processing in the acquisition unit may be performed using AI, or may be performed without using AI. For example, the acquisition unit can input the user's viewing content and interest area data to AI and have the AI perform filtering of tap information.

The acquisition unit can select an appropriate acquisition means according to the user's input method when acquiring tap information. For example, if the user is using voice input, the acquisition unit acquires tap information based on voice commands. For example, if the user is using gesture input, the acquisition unit acquires tap information based on gesture movements. The acquisition unit can also acquire tap information based on entered text if the user is using text input. This enables selection of the optimal acquisition means according to the user's input method. Some or all of the above-described processing in the acquisition unit may be performed using AI, or may be performed without using AI. For example, the acquisition unit can input the user's input method data to AI and have the AI select the optimal acquisition means.

The acquisition unit can estimate the user's emotion and determine the priority of tap information to be acquired based on the estimated user's emotion. For example, if the user is excited, the acquisition unit preferentially acquires tap information for items that attract interest. For example, if the user is relaxed, the acquisition unit preferentially acquires tap information for items with a relaxing effect. The acquisition unit can also preferentially acquire tap information for items that help reduce stress if the user is feeling stressed. This enables determination of the priority of tap information according to the user's emotion. Emotion estimation is realized, for example, by using an emotion engine or generative AI as an emotion estimation function. The generative AI may be a text generation AI (e.g., LLM) or a multimodal generative AI, but is not limited thereto. Some or all of the above-described processing in the acquisition unit may be performed using AI, or may be performed without using AI. For example, the acquisition unit can input the user's emotion data to the generative AI and have the generative AI determine the priority of tap information.

The acquisition unit can preferentially acquire highly relevant information by taking into account the user's geographic location information when acquiring tap information. For example, if the user is in a specific region, the acquisition unit preferentially acquires tap information for items related to that region. For example, if the user is traveling, the acquisition unit preferentially acquires tap information for items related to the travel destination. The acquisition unit can also preferentially acquire tap information for items related to stores or services around the user's home if the user is at home. This enables acquisition of highly relevant information by considering geographic location information. Some or all of the above-described processing in the acquisition unit may be performed using AI, or may be performed without using AI. For example, the acquisition unit can input the user's geographic location information to AI and have the AI acquire highly relevant information.

The acquisition unit can analyze the user's social media activity and acquire related information when acquiring tap information. For example, the acquisition unit acquires tap information for items related to places where the user has checked in on social media. For example, the acquisition unit analyzes the user's social media posts and acquires tap information for related items. The acquisition unit can also acquire tap information for related items by referring to the activities of the user's friends on social media. This enables acquisition of related information based on social media activity. Some or all of the above-described processing in the acquisition unit may be performed using AI, or may be performed without using AI. For example, the acquisition unit can input the user's social media activity data to AI and have the AI acquire related information.

The acquisition unit can customize the acquisition method by reflecting the user's past feedback when acquiring tap information. For example, the acquisition unit optimizes the acquisition method based on feedback provided by the user in the past. For example, the acquisition unit customizes the acquisition method for specific items based on the user's past feedback. The acquisition unit can also analyze the user's feedback and reflect improvements in the acquisition method. This enables customization of the acquisition method based on past feedback. Some or all of the above-described processing in the acquisition unit may be performed using AI, or may be performed without using AI. For example, the acquisition unit can input the user's past feedback data to AI and have the AI customize the acquisition method.

The recognition unit can estimate the user's emotion and adjust the accuracy of item recognition based on the estimated user's emotion. For example, if the user is excited, the recognition unit increases the recognition accuracy and immediately recognizes the item. For example, if the user is relaxed, the recognition unit slightly relaxes the recognition accuracy and recognizes the item in a natural flow. The recognition unit can also optimize the recognition accuracy to reduce the user's burden if the user is feeling stressed. This enables adjustment of item recognition accuracy according to the user's emotion. Emotion estimation is realized, for example, by using an emotion engine or generative AI as an emotion estimation function. The generative AI may be a text generation AI (e.g., LLM) or a multimodal generative AI, but is not limited thereto. Some or all of the above-described processing in the recognition unit may be performed using AI, or may be performed without using AI. For example, the recognition unit can input the user's emotion data to the generative AI and have the generative AI adjust the accuracy of item recognition.

The recognition unit can adjust the recognition accuracy based on the importance of the item during recognition. For example, the recognition unit performs detailed recognition for highly important items. For example, the recognition unit performs simplified recognition for less important items. The recognition unit can also dynamically adjust the recognition accuracy according to the importance of the item. This enables adjustment of recognition accuracy according to the importance of the item. Some or all of the above-described processing in the recognition unit may be performed using AI, or may be performed without using AI. For example, the recognition unit can input item importance data to AI and have the AI adjust the recognition accuracy.

The recognition unit can apply different recognition algorithms according to the category of the item during recognition. For example, the recognition unit applies a fashion-specific recognition algorithm to clothing items. For example, the recognition unit applies a technology-specific recognition algorithm to electronic device items. The recognition unit can also apply a food-specific recognition algorithm to food items. This enables application of recognition algorithms according to the category of the item. Some or all of the above-described processing in the recognition unit may be performed using AI, or may be performed without using AI. For example, the recognition unit can input item category data to AI and have the AI apply the recognition algorithm.

The recognition unit can improve recognition accuracy by referring to the user's past recognition results during recognition. For example, the recognition unit improves recognition accuracy based on data of items recognized by the user in the past. For example, the recognition unit adjusts recognition accuracy for specific items based on the user's past recognition results. The recognition unit can also analyze the user's past recognition history and optimize the recognition algorithm. This enables improvement of recognition accuracy based on past recognition results. Some or all of the above-described processing in the recognition unit may be performed using AI, or may be performed without using AI. For example, the recognition unit can input the user's past recognition result data to AI and have the AI improve recognition accuracy.

The recognition unit can estimate the user's emotion and determine the recognition priority based on the estimated user's emotion. For example, if the user is excited, the recognition unit preferentially recognizes items that attract interest. For example, if the user is relaxed, the recognition unit preferentially recognizes items with a relaxing effect. The recognition unit can also preferentially recognize items that help reduce stress if the user is feeling stressed. This enables determination of recognition priority according to the user's emotion.

Emotion estimation is realized, for example, by using an emotion engine or generative AI as an emotion estimation function. The generative AI may be a text generation AI (e.g., LLM) or a multimodal generative AI, but is not limited thereto. Some or all of the above-described processing in the recognition unit may be performed using AI, or may be performed without using AI. For example, the recognition unit can input the user's emotion data to the generative AI and have the generative AI determine the recognition priority.

The recognition unit can determine the recognition priority based on the submission timing of the item during recognition. For example, the recognition unit preferentially recognizes recently tapped items. For example, the recognition unit postpones items that have not been tapped for a long time. The recognition unit can also dynamically adjust the recognition priority according to the submission timing. This enables determination of recognition priority according to the submission timing.

Some or all of the above-described processing in the recognition unit may be performed using AI, or may be performed without using AI. For example, the recognition unit can input item submission timing data to AI and have the AI determine the recognition priority.

The recognition unit can adjust the recognition order based on the relevance of the item during recognition. For example, the recognition unit preferentially recognizes highly relevant items. For example, the recognition unit postpones less relevant items. The recognition unit can also dynamically adjust the recognition order according to the relevance of the item. This enables adjustment of the recognition order according to the relevance of the item. Some or all of the above-described processing in the recognition unit may be performed using AI, or may be performed without using AI. For example, the recognition unit can input item relevance data to AI and have the AI adjust the recognition order.

The recognition unit can adjust the use of technical terms in recognition results according to the user's level of expertise during recognition. For example, for users with a high level of expertise, the recognition unit provides recognition results using detailed technical terms. For example, for users with a low level of expertise, the recognition unit provides recognition results using simple terms. The recognition unit can also dynamically adjust the use of technical terms in recognition results according to the user's level of expertise. This enables adjustment of the use of technical terms in recognition according to the user's level of expertise. Some or all of the above-described processing in the recognition unit may be performed using AI, or may be performed without using AI. For example, the recognition unit can input the user's expertise level data to AI and have the AI perform the use of technical terms.

The reference unit can estimate the user's emotion and select the database to refer to based on the estimated user's emotion. For example, if the user is excited, the reference unit preferentially refers to entertainment-related databases. For example, if the user is relaxed, the reference unit preferentially refers to databases with a relaxing effect. The reference unit can also preferentially refer to databases that help reduce stress if the user is feeling stressed. This enables selection of the database to refer to according to the user's emotion. Emotion estimation is realized, for example, by using an emotion engine or generative AI as an emotion estimation function. The generative AI may be a text generation AI (e.g., LLM) or a multimodal generative AI, but is not limited thereto. Some or all of the above-described processing in the reference unit may be performed using AI, or may be performed without using AI. For example, the reference unit can input the user's emotion data to the generative AI and have the generative AI select the database.

The reference unit can adjust the reference accuracy based on the importance of the item during reference. For example, the reference unit refers to detailed information for highly important items. For example, the reference unit refers to simplified information for less important items. The reference unit can also dynamically adjust the reference accuracy according to the importance of the item. This enables adjustment of reference accuracy according to the importance of the item. Some or all of the above-described processing in the reference unit may be performed using AI, or may be performed without using AI. For example, the reference unit can input item importance data to AI and have the AI adjust the reference accuracy.

The reference unit can apply different reference algorithms according to the category of the item during reference. For example, the reference unit applies a fashion-specific reference algorithm to clothing items. For example, the reference unit applies a technology-specific reference algorithm to electronic device items. The reference unit can also apply a food-specific reference algorithm to food items. This enables application of reference algorithms according to the category of the item. Some or all of the above-described processing in the reference unit may be performed using AI, or may be performed without using AI. For example, the reference unit can input item category data to AI and have the AI apply the reference algorithm.

The reference unit can improve reference accuracy by referring to the user's past reference results during reference. For example, the reference unit improves reference accuracy based on data of items referred to by the user in the past. For example, the reference unit adjusts reference accuracy for specific items based on the user's past reference results. The reference unit can also analyze the user's past reference history and optimize the reference algorithm. This enables improvement of reference accuracy based on past reference results. Some or all of the above-described processing in the reference unit may be performed using AI, or may be performed without using AI. For example, the reference unit can input the user's past reference result data to AI and have the AI improve reference accuracy.

The reference unit can estimate the user's emotion and determine the reference priority based on the estimated user's emotion. For example, if the user is excited, the reference unit preferentially refers to items that attract interest. For example, if the user is relaxed, the reference unit preferentially refers to items with a relaxing effect. The reference unit can also preferentially refer to items that help reduce stress if the user is feeling stressed. This enables determination of reference priority according to the user's emotion. Emotion estimation is realized, for example, by using an emotion engine or generative AI as an emotion estimation function. The generative AI may be a text generation AI (e.g., LLM) or a multimodal generative AI, but is not limited thereto. Some or all of the above-described processing in the reference unit may be performed using AI, or may be performed without using AI. For example, the reference unit can input the user's emotion data to the generative AI and have the generative AI determine the reference priority.

The reference unit can determine the reference priority based on the submission timing of the item during reference. For example, the reference unit preferentially refers to recently tapped items. For example, the reference unit postpones items that have not been tapped for a long time. The reference unit can also dynamically adjust the reference priority according to the submission timing. This enables determination of reference priority according to the submission timing. Some or all of the above-described processing in the reference unit may be performed using AI, or may be performed without using AI. For example, the reference unit can input item submission timing data to AI and have the AI determine the reference priority.

The reference unit can adjust the reference order based on the relevance of the item during reference. For example, the reference unit preferentially refers to highly relevant items. For example, the reference unit postpones less relevant items. The reference unit can also dynamically adjust the reference order according to the relevance of the item. This enables adjustment of the reference order according to the relevance of the item.

Some or all of the above-described processing in the reference unit may be performed using AI, or may be performed without using AI. For example, the reference unit can input item relevance data to AI and have the AI adjust the reference order.

The reference unit can adjust the use of technical terms in reference results according to the user's level of expertise during reference. For example, for users with a high level of expertise, the reference unit provides reference results using detailed technical terms. For example, for users with a low level of expertise, the reference unit provides reference results using simple terms. The reference unit can also dynamically adjust the use of technical terms in reference results according to the user's level of expertise. This enables adjustment of the use of technical terms in reference according to the user's level of expertise. Some or all of the above-described processing in the reference unit may be performed using AI, or may be performed without using AI. For example, the reference unit can input the user's expertise level data to AI and have the AI perform the use of technical terms.

The provision unit can estimate the user's emotion and adjust the method of information provision based on the estimated user's emotion. For example, if the user is excited, the provision unit provides information in a visually stimulating manner. For example, if the user is relaxed, the provision unit provides information in a calm manner. The provision unit can also provide information in a simple and highly visible manner if the user is feeling stressed. This enables adjustment of the method of information provision according to the user's emotion. Emotion estimation is realized, for example, by using an emotion engine or generative AI as an emotion estimation function. The generative AI may be a text generation AI (e.g., LLM) or a multimodal generative AI, but is not limited thereto. Some or all of the above-described processing in the provision unit may be performed using AI, or may be performed without using AI. For example, the provision unit can input the user's emotion data to the generative AI and have the generative AI adjust the method of information provision.

The provision unit can adjust the provision accuracy based on the importance of the information during provision. For example, the provision unit provides detailed information for highly important information. For example, the provision unit provides simplified information for less important information. The provision unit can also dynamically adjust the provision accuracy according to the importance of the information. This enables adjustment of provision accuracy according to the importance of the information. Some or all of the above-described processing in the provision unit may be performed using AI, or may be performed without using AI. For example, the provision unit can input information importance data to AI and have the AI adjust the provision accuracy.

The provision unit can apply different provision algorithms according to the category of the information during provision. For example, the provision unit applies a fashion-specific provision algorithm to clothing information. For example, the provision unit applies a technology-specific provision algorithm to electronic device information. The provision unit can also apply a food-specific provision algorithm to food information. This enables application of provision algorithms according to the category of the information. Some or all of the above-described processing in the provision unit may be performed using AI, or may be performed without using AI. For example, the provision unit can input information category data to AI and have the AI apply the provision algorithm.

The provision unit can improve provision accuracy by referring to the user's past provision results during provision. For example, the provision unit improves provision accuracy based on data of information provided to the user in the past. For example, the provision unit adjusts provision accuracy for specific information based on the user's past provision results. The provision unit can also analyze the user's past provision history and optimize the provision algorithm. This enables improvement of provision accuracy based on past provision results. Some or all of the above-described processing in the provision unit may be performed using AI, or may be performed without using AI. For example, the provision unit can input the user's past provision result data to AI and have the AI improve provision accuracy.

The provision unit can estimate the user's emotion and determine the priority of information to be provided based on the estimated user's emotion. For example, if the user is excited, the provision unit preferentially provides information that attracts interest. For example, if the user is relaxed, the provision unit preferentially provides information with a relaxing effect. The provision unit can also preferentially provide information that helps reduce stress if the user is feeling stressed. This enables determination of the priority of information to be provided according to the user's emotion. Emotion estimation is realized, for example, by using an emotion engine or generative AI as an emotion estimation function. The generative AI may be a text generation AI (e.g., LLM) or a multimodal generative AI, but is not limited thereto. Some or all of the above-described processing in the provision unit may be performed using AI, or may be performed without using AI. For example, the provision unit can input the user's emotion data to the generative AI and have the generative AI determine the priority of information.

The provision unit can determine the provision priority based on the submission timing of the information during provision. For example, the provision unit preferentially provides recently acquired information. For example, the provision unit postpones information that has not been acquired for a long time. The provision unit can also dynamically adjust the provision priority according to the submission timing. This enables determination of provision priority according to the submission timing. Some or all of the above-described processing in the provision unit may be performed using AI, or may be performed without using AI. For example, the provision unit can input information submission timing data to AI and have the AI determine the provision priority.

The provision unit can adjust the provision order based on the relevance of the information during provision. For example, the provision unit preferentially provides highly relevant information. For example, the provision unit postpones less relevant information. The provision unit can also dynamically adjust the provision order according to the relevance of the information. This enables adjustment of the provision order according to the relevance of the information. Some or all of the above-described processing in the provision unit may be performed using AI, or may be performed without using AI. For example, the provision unit can input information relevance data to AI and have the AI adjust the provision order.

The provision unit can adjust the use of technical terms in information provision according to the user's level of expertise during provision. For example, for users with a high level of expertise, the provision unit provides information using detailed technical terms. For example, for users with a low level of expertise, the provision unit provides information using simple terms. The provision unit can also dynamically adjust the use of technical terms in provided information according to the user's level of expertise. This enables adjustment of the use of technical terms in provision according to the user's level of expertise. Some or all of the above-described processing in the provision unit may be performed using AI, or may be performed without using AI. For example, the provision unit can input the user's expertise level data to AI and have the AI perform the use of technical terms.

### Hardware Guarantee 1-1

Each of the plurality of elements including the above-described acquisition unit, recognition unit, reference unit, and provision unit is realized by at least one of, for example, the smart device 14 and the data processing apparatus 12. For example, the acquisition unit acquires tap information of the viewer using the touch panel 38A of the smart device 14. The recognition unit is realized, for example, by the specific processing unit 290 of the data processing apparatus 12 and recognizes the tapped item using image recognition technology. The reference unit is realized, for example, by the specific processing unit 290 of the data processing apparatus 12 and acquires related information by referring to the EC database 24. The provision unit provides information to the viewer using, for example, the output device 40 of the smart device 14.

### Hardware Guarantee 1-2

Each of the plurality of elements including the above-described acquisition unit, recognition unit, reference unit, and provision unit is realized by at least one of, for example, the smart glasses 214 and the data processing apparatus 12. For example, the acquisition unit acquires tap information of the viewer using the touch panel of the smart glasses 214. The recognition unit is realized, for example, by the specific processing unit 290 of the data processing apparatus 12 and recognizes the tapped item using image recognition technology. The reference unit is realized, for example, by the specific processing unit 290 of the data processing apparatus 12 and acquires related information by referring to the EC database 24. The provision unit provides information to the viewer using, for example, the display of the smart glasses 214.

### Hardware Guarantee 1-3

Each of the plurality of elements including the above-described acquisition unit, recognition unit, reference unit, and provision unit is realized by at least one of, for example, the headset-type terminal 314 and the data processing apparatus 12. For example, the acquisition unit acquires tap information of the viewer using the touch panel of the headset-type terminal 314. The recognition unit is realized, for example, by the specific processing unit 290 of the data processing apparatus 12 and recognizes the tapped item using image recognition technology. The reference unit is realized, for example, by the specific processing unit 290 of the data processing apparatus 12 and acquires related information by referring to the EC database 24. The provision unit provides information to the viewer using, for example, the display of the headset-type terminal 314.

### Hardware Guarantee 1-4

Each of the plurality of elements including the above-described acquisition unit, recognition unit, reference unit, and provision unit is realized by at least one of, for example, the robot 414 and the data processing apparatus 12. For example, the acquisition unit acquires tap information of the viewer using the touch panel of the robot 414. The recognition unit is realized, for example, by the specific processing unit 290 of the data processing apparatus 12 and recognizes the tapped item using image recognition technology. The reference unit is realized, for example, by the specific processing unit 290 of the data processing apparatus 12 and acquires related information by referring to the EC database 24. The provision unit provides information to the viewer using, for example, the display of the robot 414.

The system according to the embodiment is not limited to the above-described examples, and various modifications are possible, for example, as follows.

The acquisition unit can analyze the user's past purchase history and preferentially acquire information about related items. For example, the acquisition unit preferentially acquires tap information for similar items based on data of items the user has purchased in the past. The acquisition unit can also analyze the user's interest in specific brands or categories from the purchase history and preferentially acquire such information. Furthermore, the acquisition unit can preferentially acquire information about items according to the season or trend based on the user's purchase history. This enables efficient acquisition of related information based on the user's purchase history.

The recognition unit can utilize the user's gaze tracking data to preferentially recognize items on which the gaze is focused. For example, the recognition unit preferentially recognizes items on which the user's gaze remains for a long time. The recognition unit can also analyze gaze movement patterns and preferentially recognize items that are likely to be of interest. Furthermore, the recognition unit can adjust the recognition accuracy according to the degree of gaze concentration and enhance the recognition accuracy for items on which the gaze is focused. This enables efficient recognition of items of interest by utilizing the user's gaze data.

The reference unit can analyze the user's social media activity and acquire related information. For example, the reference unit preferentially acquires information about brands or influencers followed by the user on social media. The reference unit can also analyze the user's posts and comments to acquire information related to topics of interest. Furthermore, the reference unit can acquire related information by referring to the activities of the user's friends on social media. This enables efficient acquisition of related information based on social media activity.

The provision unit can adjust the method of information provision based on the user's device usage status. For example, if the user is using a smartphone, the provision unit provides information in a manner suitable for the screen size. The provision unit can also provide information in a manner that utilizes the large screen if the user is using a tablet. Furthermore, if the user is using a desktop, the provision unit can provide information using multiple windows. This enables provision of information in the optimal manner according to the user's device usage status.

The acquisition unit can estimate the user's emotion and determine the type of information to be acquired based on the estimated user's emotion. For example, if the user is excited, the acquisition unit preferentially acquires entertainment-related information. The acquisition unit can also preferentially acquire information with a relaxing effect if the user is relaxed. Furthermore, the acquisition unit can preferentially acquire information that helps reduce stress if the user is feeling stressed. This enables optimization of the type of information to be acquired according to the user's emotion.

The recognition unit can estimate the user's emotion and determine the recognition priority based on the estimated user's emotion. For example, if the user is excited, the recognition unit preferentially recognizes items that attract interest. The recognition unit can also preferentially recognize items with a relaxing effect if the user is relaxed. Furthermore, the recognition unit can preferentially recognize items that help reduce stress if the user is feeling stressed. This enables determination of recognition priority according to the user's emotion.

The reference unit can estimate the user's emotion and select the database to refer to based on the estimated user's emotion. For example, if the user is excited, the reference unit preferentially refers to entertainment-related databases. The reference unit can also preferentially refer to databases with a relaxing effect if the user is relaxed. Furthermore, the reference unit can preferentially refer to databases that help reduce stress if the user is feeling stressed. This enables selection of the database to refer to according to the user's emotion.

The provision unit can estimate the user's emotion and adjust the method of information provision based on the estimated user's emotion. For example, if the user is excited, the provision unit provides information in a visually stimulating manner. The provision unit can also provide information in a calm manner if the user is relaxed. Furthermore, the provision unit can provide information in a simple and highly visible manner if the user is feeling stressed. This enables adjustment of the method of information provision according to the user's emotion.

The provision unit can estimate the user's emotion and determine the priority of information to be provided based on the estimated user's emotion. For example, if the user is excited, the provision unit preferentially provides information that attracts interest. The provision unit can also preferentially provide information with a relaxing effect if the user is relaxed. Furthermore, the provision unit can preferentially provide information that helps reduce stress if the user is feeling stressed. This enables determination of the priority of information to be provided according to the user's emotion.

The acquisition unit can preferentially acquire highly relevant information by taking into account the user's geographic location information. For example, if the user is in a specific region, the acquisition unit preferentially acquires tap information for items related to that region. The acquisition unit can also preferentially acquire tap information for items related to the travel destination if the user is traveling. Furthermore, if the user is at home, the acquisition unit can preferentially acquire tap information for items related to stores or services around the user's home. This enables acquisition of highly relevant information by considering geographic location information.

The following is a brief description of the processing flow of Example 2 of the Embodiment.

Step 1: The acquisition unit acquires tap information when a viewer taps an item of interest while watching video content on a device. For example, the acquisition unit can acquire information such as the position, time, and strength of the tap. The acquisition unit can also estimate the user's emotion and adjust the timing of acquiring tap information based on the estimated user's emotion.

Step 2: The recognition unit recognizes the tapped item based on the tap information acquired by the acquisition unit. For example, the recognition unit can recognize the tapped item using image recognition technology. The recognition unit can also estimate the user's emotion and adjust the accuracy of item recognition based on the estimated user's emotion.

Step 3: The reference unit acquires related information based on the item information recognized by the recognition unit. For example, the reference unit can refer to EC databases and other related databases to obtain detailed product information, reviews, prices, etc. The reference unit can also estimate the user's emotion and select the database to refer to based on the estimated user's emotion.

Step 4: The provision unit provides the information acquired by the reference unit to the viewer. For example, the provision unit can provide information by means such as pop-up display, notification, or email. The provision unit can also estimate the user's emotion and adjust the method of information provision based on the estimated user's emotion.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT (registered trademark) (Internet search <URL: https://openai. com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

The correspondence between each unit and the device or control unit is not limited to the above-described example, and various modifications are possible.

### Second Embodiment

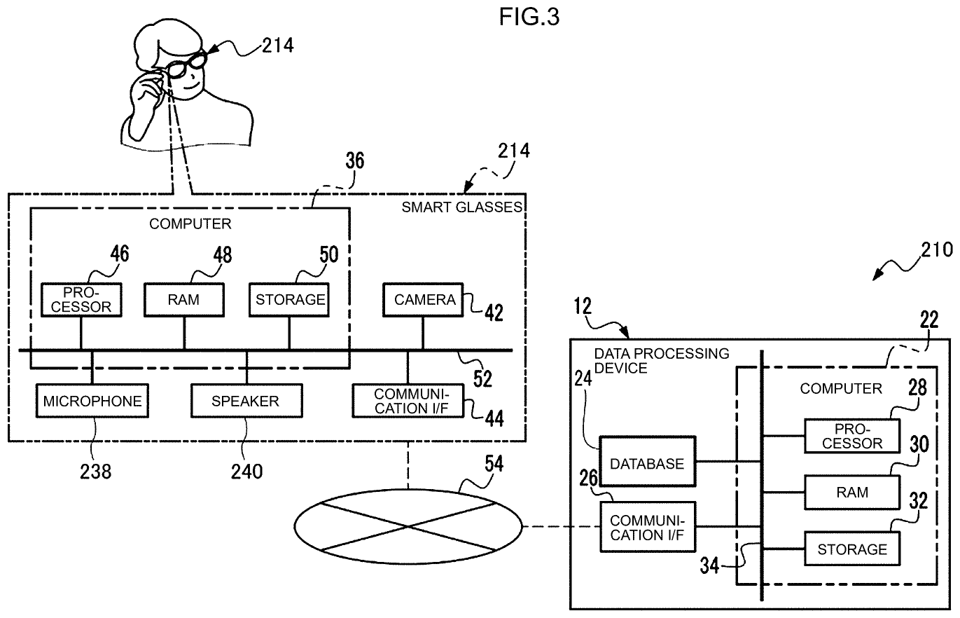

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

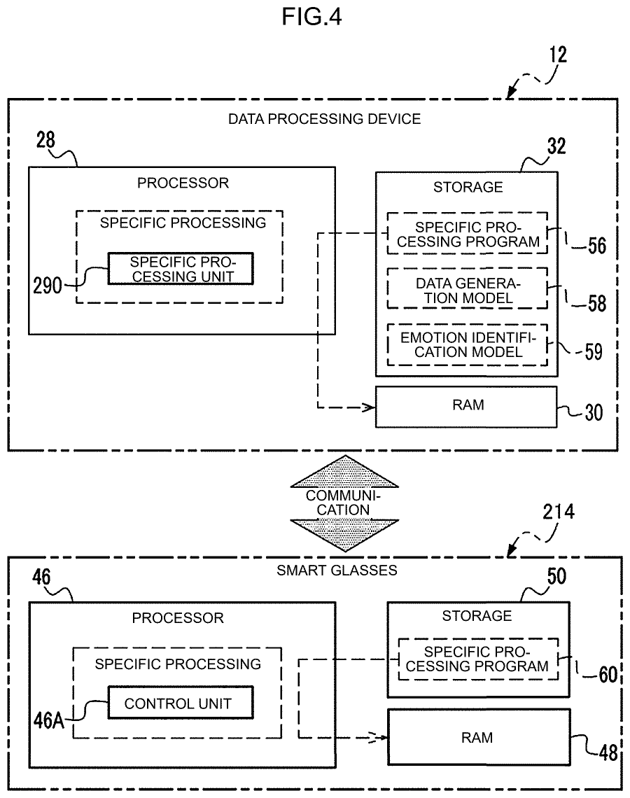

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

The correspondence between each unit and the device or control unit is not limited to the above-described example, and various modifications are possible.

### Third Embodiment

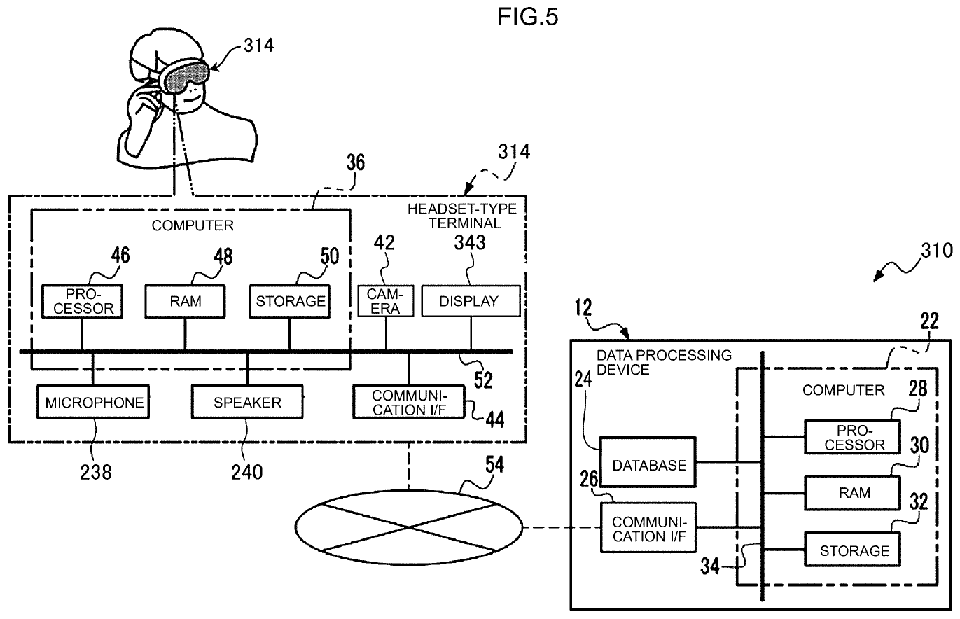

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

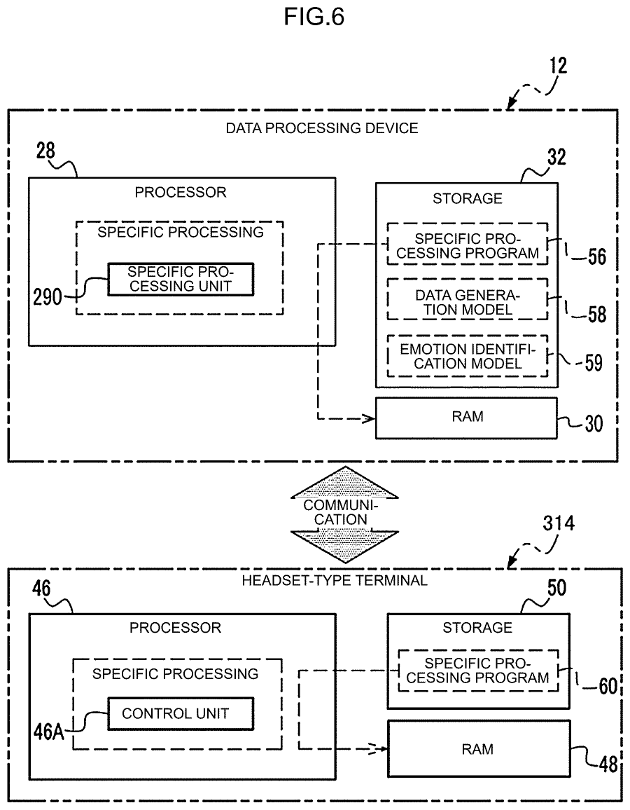

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent.

Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

The correspondence between each unit and the device or control unit is not limited to the above-described example, and various modifications are possible.

### Fourth Embodiment

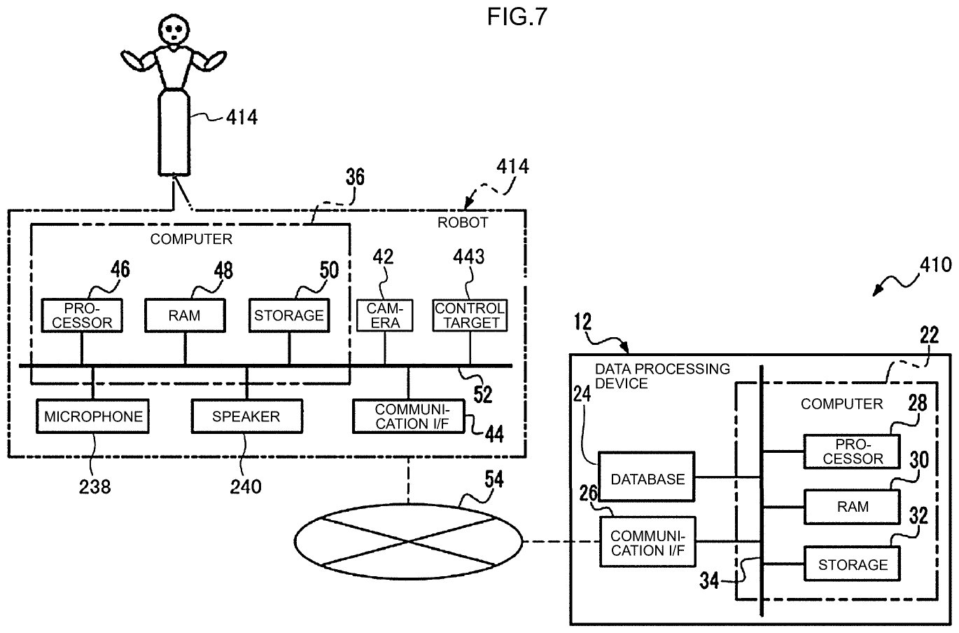

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

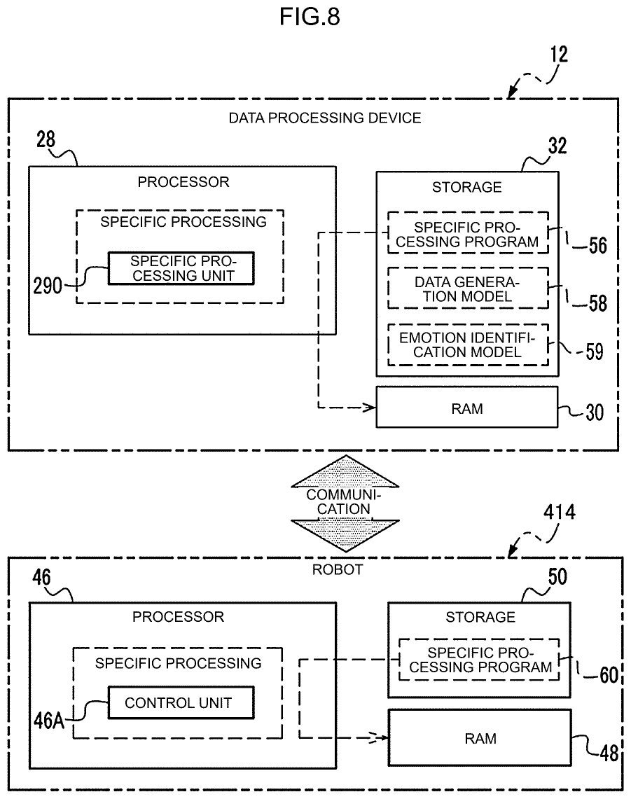

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

The correspondence between each unit and the device or control unit is not limited to the above-described example, and various modifications are possible.

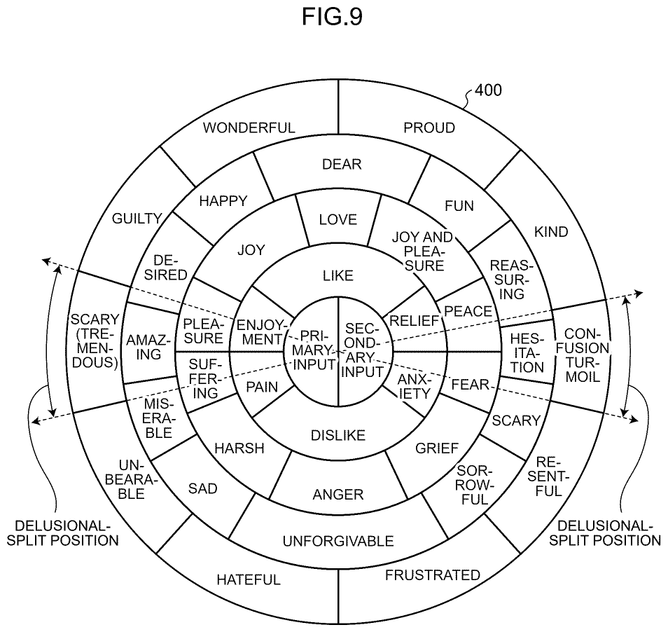

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr.

Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

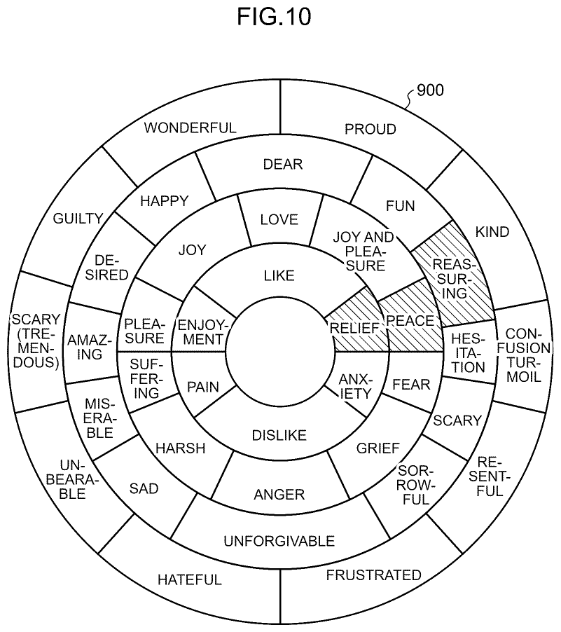

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used. Additionally, the examples described above were explained by dividing into form example 1 and form example 2, but these may be combined.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

What is claimed is:

1. A system comprising: an acquisition unit that acquires tap information; a recognition unit that recognizes an item based on the tap information acquired by the acquisition unit; a reference unit that acquires related information based on the item information recognized by the recognition unit; and a provision unit that provides the information acquired by the reference unit.

2. The system according to claim 1, wherein the reference unit refers to an EC database.

3. The system according to claim 1, wherein the reference unit refers to other related databases.

4. The system according to claim 1, wherein the recognition unit recognizes the tapped item.

5. The system according to claim 1, wherein the provision unit provides information to a viewer.

6. The system according to claim 1, wherein the acquisition unit estimates the user's emotion and adjusts the timing of acquiring tap information based on the estimated user's emotion.

7. The system according to claim 1, wherein the acquisition unit analyzes the user's past tap history and selects an appropriate acquisition method.

8. The system according to claim 1, wherein the acquisition unit performs filtering based on the user's current viewing content and areas of interest when acquiring tap information.

9. The system according to claim 1, wherein the acquisition unit selects an appropriate acquisition means according to the user's input method when acquiring tap information.
